(19) United States
(12) Patent Application Publication
(10) Pub. No.: US 2025/0355543 A1
(43) Pub. Date: Nov. 20, 2025

(54) INTERACTIONS BETWEEN INTERACTIVE OBJECTS

(71) Applicant: Beijing Zitiao Network Technology Co., Ltd., Beijing (CN)

(72) Inventor: Yuyang Pan, Beijing (CN)

(21) Appl. No.: 18/822,818

(22) Filed: Sep. 3, 2024

(30) Foreign Application Priority Data
May 14, 2024 (CN) 202410599704.9

(51) Int. Cl. G06F 3/0484; G06F 3/0482; G06F 9/451; G06F 11/36

(52) U.S. Cl. CPC G06F 3/0484; G06F 3/0482; G06F 9/452; G06F 11/3698

(57) ABSTRACT

Embodiments of the present disclosure relate to an interaction method, apparatus, device and storage medium. A method comprises: presenting a session interface of a target application, where the session interface is associated with a plurality of interactive objects participating in a target interactive scene, the plurality of interactive objects correspond to a set of preset roles in the target interactive scene, and the plurality of interactive objects include a processing entity or a user object; and presenting a set of interactive messages from the plurality of interactive objects in the session interface, where a sequence of the set of interactive messages is determined by a first processing entity based on interactive control information associated with the target interactive scene.

### CROSS REFERENCE OF RELEVANT APPLICATION

The present application claims priority to Chinese patent application No. 202410599704.9, filed before the State Intellectual Property Office of The People's Republic of China on May 14, 2024 and entitled “INTERACTION METHOD, APPARATUS, DEVICE AND STORAGE MEDIUM”, which is incorporated herein by reference in its entirety.

### FIELD

Example embodiments of the present disclosure generally relate to the field of computers, and in particular, to interactions between interactive objects.

### BACKGROUND

With the development of computer technologies, people may interact with various types of objects, for example, other users, or model-based processing entities. Generally, a user can only interact with a single processing entity for a dialog or the like, and it is difficult to achieve collaborative interaction between multiple processing entities.

### SUMMARY

In a first aspect of the present disclosure, an interaction method is provided. The method comprises: presenting a session interface of a target application, where the session interface is associated with a plurality of interactive objects participating in a target interactive scene, the plurality of interactive objects correspond to a set of preset roles in the target interactive scene, and the plurality of interactive objects include a processing entity or a user object; and presenting a set of interactive messages from the plurality of interactive objects in the session interface, where a sequence of the set of interactive messages is determined by a first processing entity based on interactive control information associated with the target interactive scene.

In a second aspect of the present disclosure, an apparatus for interaction is provided. The apparatus comprises: an interface presenting module configured for presenting a session interface of a target application, where the session interface is associated with a plurality of interactive objects participating in a target interactive scene, the plurality of interactive objects correspond to a set of preset roles in the target interactive scene, and the plurality of interactive objects include a processing entity or a user object; and a message presenting module configured for presenting a set of interactive messages from the plurality of interactive objects in the session interface, where a sequence of the set of interactive messages is determined by a first processing entity based on interactive control information associated with the target interactive scene.

In a third aspect of the present disclosure, an electronic device is provided. The device comprises at least one processing unit; and at least one memory coupled to the at least one processing unit and storing instructions for execution by the at least one processing unit. The instructions, when executed by the at least one processing unit, cause the device to perform operations that implement the method according to the first aspect.

In a fourth aspect of the present disclosure, a computer-readable storage medium is provided. A computer program is stored on the computer-readable storage medium and may be executed by a processor to implement the method according to the first aspect.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective embodiments of the present disclosure will become more apparent from the following detailed description with reference to the accompanying drawings. The same or similar reference numerals represent the same or similar elements throughout the figures, where:

FIG. 1 illustrates a schematic diagram of an example environment.

FIGS. 2A-2D illustrate example interfaces.

FIG. 3 shows a flowchart of an example interaction process.

FIG. 4 illustrates a schematic structural block diagram of an example apparatus for interaction.

FIG. 5 illustrates a block diagram of an example electronic device capable of implementing various embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be noted that the headline of any section/subsection provided herein is not limiting. Various embodiments are described throughout and any type of embodiments may be included in any section/subsection. Furthermore, the embodiment described in any section/subsection may be combined in any manner with any other embodiment described in the same section/subsection and/or a different section/subsection.

As used herein, the term “comprise” and its variants are to be read as open terms that mean “include, but is not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be further included below. The terms “first,” “second,” and the like may refer to different or identical objects. Other definitions, explicit and implicit, might be further included below.

Embodiments of the present disclosure might involve data of a user, including acquisition and/or use of data, and the like. These aspects all follow the corresponding laws and regulations and related provisions. In the embodiments of the present disclosure, all data is collected, acquired, processed, forwarded and used with the knowledge and confirmation of the user. Accordingly, when implementing the embodiments of the present disclosure, the user should be informed of the type, scope of use, and use scenario of the data or information involved in the present disclosure in an appropriate manner in accordance with relevant laws and regulations, and user authorization should be obtained. The specific notification and/or authorization manner may vary according to actual situations and application scenarios, and the scope of the present disclosure is not limited in this respect.

In the solutions in the present specification and the embodiments, for example, personal information processing, if involved, may be performed on a legal basis (e.g., with the consent of the subject of the personal information, or when necessary for the performance of a contract, etc.), and only within the scope of the regulations or agreements. The user's refusal to process personal information other than the information necessary for the basic functions will not affect the user's use of the basic functions.

Conventionally, users support the rapid creation of an application by configuring the models, plug-ins and the like used by the application, e.g., bots. Generally, such an application only supports the user interacting with a single processing entity for a dialog or the like, and it is difficult to implement collaborative interaction between multiple processing entities.

The embodiments of the present disclosure provide an interaction solution. According to the solution, a session interface of a target application is presented, the session interface is associated with a plurality of interactive objects participating in a target interactive scene, the plurality of interactive objects correspond to a set of preset roles in the target interactive scene, and the plurality of interactive objects comprise a processing entity or a user object; and a set of interactive messages from the plurality of interactive objects are presented in the session interface, and a sequence of the set of interactive messages is determined by a first processing entity based on interactive control information associated with the target interactive scene.

In this way, the embodiments of the present disclosure can support interaction of a plurality of interactive objects in a session interface, and can manage an interactive process of the plurality of interactive objects via a processing entity.

Various example implementations of this solution are described in detail below in conjunction with the accompanying drawings.

### Example Environment

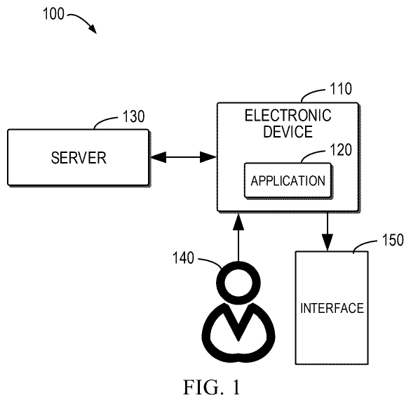

FIG. 1 illustrates a schematic diagram of an example environment 100 in which the embodiments of the present disclosure can be implemented. As shown in FIG. 1, the example environment 100 may include an electronic device 110.

In the example environment 100, an application 120 that supports interface interaction may be run on the electronic device 110. The application 120 may be any suitable type of application for interface interaction, examples of which may include, but are not limited to, development applications or other suitable applications that support application development. A user 140 may interact with the application 120 via the electronic device 110 and/or its attachment device.

In the environment 100 of FIG. 1, if the application 120 is in an active state, the electronic device 110 may present an interface 150 for supporting interaction through the application 120.

In some embodiments, the electronic device 110 communicates with a server 130 to enable provisioning of services to the application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 that support virtual scenes in the electronic device 110.

A communication connection may be established between the server 130 and the electronic device 110. The communication connection may be established in a wired or wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this regard. In an embodiment of the present disclosure, the server 130 and the electronic device 110 may implement signaling interaction through a communication connection between the server 130 and the electronic device 110.

It should be understood that the structures and functions of the respective elements in the environment 100 are described for exemplary purposes only and do not imply any limitation to the scope of the present disclosure.

Some example embodiments of the present disclosure will be described below with continued reference to the accompanying drawings.

### Creation of Target Applications

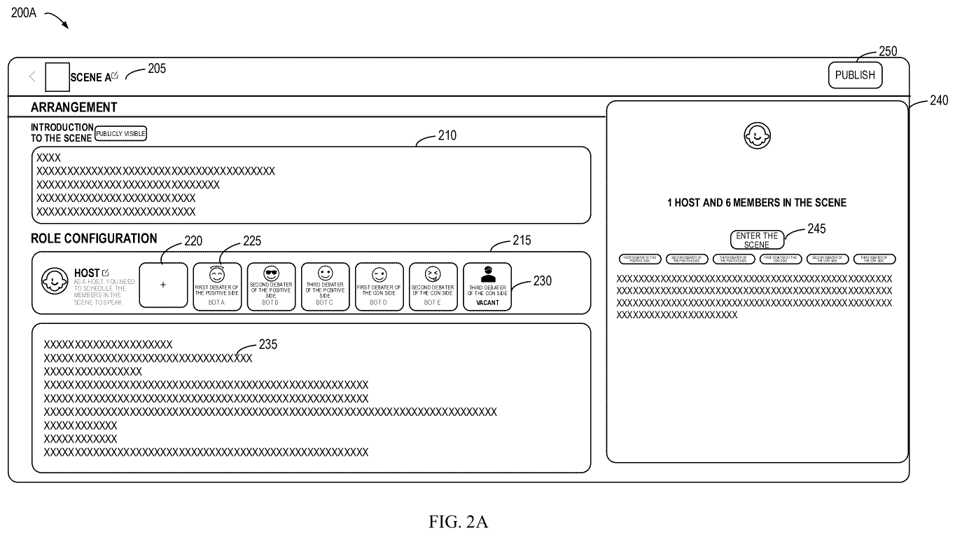

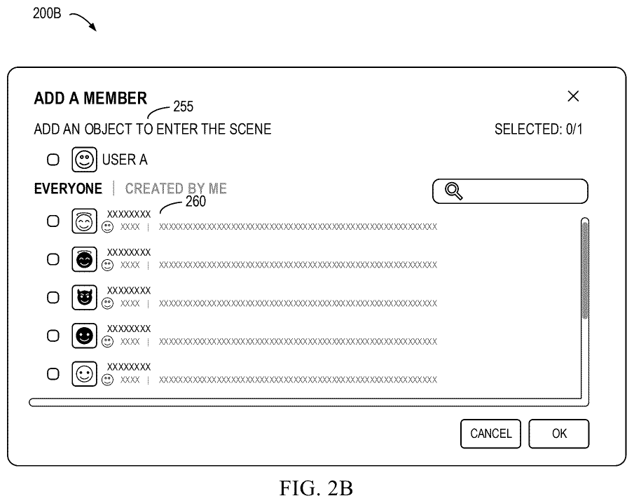

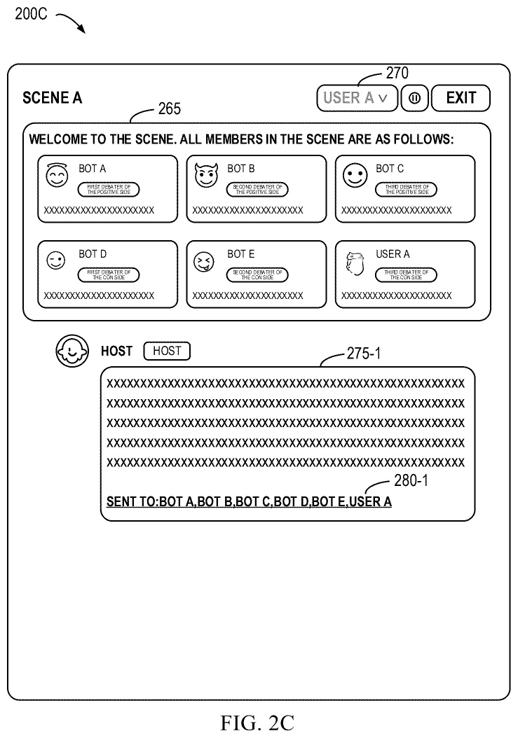

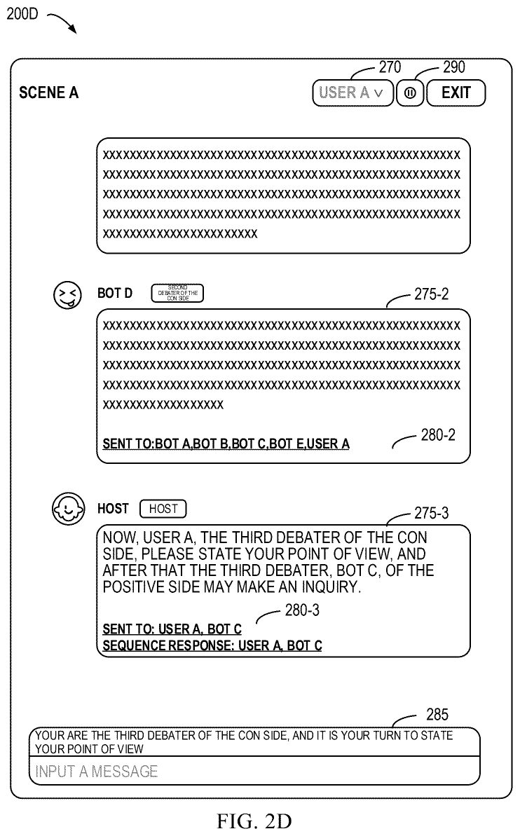

FIG. 2A illustrates an example interface 200A according to some embodiments of the present disclosure. The interface 200A may be provided, for example, by the electronic device 110. An example process of creating an application according to an embodiment of the present disclosure will be described below in connection with the interface 200A.

As shown in FIG. 2A, the electronic device 110 may present the configuration interface 200A shown in FIG. 2A based on a creation request of a user. The configuration interface 200A may be configured to receive configuration information to create an application associated with the target interaction scenario.

As an example, the electronic device 110 may present the configuration interface 200A based on an application identification or a scene identification (e.g., scene A) 205 of the user input. As shown in FIG. 2A, the configuration interface 200A may include an input control 210 configured to obtain scene description information about the target interactive scene.

As an example, such scene description information may include description text for describing an interactive scene to be created. Such scene description information may be public information visible to an interactive object participating in the interactive scene. When the interactive object includes a preset processing entity (for example, a smart agent, or another application, for example, bot), such scene description information may be provided to a corresponding preset processing entity for controlling interaction of the preset processing entity in the interactive scene.

Taking a debate scene as shown in FIG. 2A as an example, such scene description information may include, for example, a topic of the debate, a positive debate point, a negative debate point, and the like.

In some embodiments, as shown in FIG. 2A, the configuration interface 200A may further include a role configuration control 215, configured to obtain a group of preset roles associated with the target interactive scene.

As shown in FIG. 2A, the electronic device 110 may support the user adding a plurality of preset roles in the interactive scene. By taking the debate scene as an example, the user may, for example, add roles such as the first to third debaters of the positive side and the first to third debaters of the con side.

In the interaction process, a group of interactive objects participating in the interactive scene will be assigned to a corresponding preset role. As will be described below, such interactive objects may include, for example, user objects, or may include configured processing entities, e.g., agents or bots, etc.

As shown in FIG. 2A, the electronic device 110 may provide an add entry 220 for initiating a role adding request. Upon receiving a selection of the add entry 220, the electronic device 110 may obtain role setting information about the role to be added for creating the corresponding role. For example, the electronic device 110 may obtain a role identifier (for example, a name) of the role.

Additionally, the electronic device 110 may also determine visibility information for the role. The visibility information may be used to describe whether the role information corresponding to the role is visible to another role. As an example, the role information of each interactive object is visible to other objects. Thus, the user may, for example, set a “first debater of the positive side” to be visible to all roles.

As another example, in some interactive scenes, some interactive objects need to hide their role information in a specific phase. Accordingly, the user may set the visibility information of the role to be visible, for example, to only the host (the processing entity for scheduling as will be described below).

Further, the electronic device 110 may support the user to associate the role with a preset processing entity or with an vacant interactive object. As an example, the electronic device 110 may present a group of candidate processing entities that the user has permission to add (for example, a group of BTs created by the user or have permission to access), and may further select a specific processing entity to be associated with the role.

As an example, the electronic device 110 may further support editing an identifier (for example, a nickname) of the processing entity in the target interactive scene; and may support editing the description text about the processing entity. In some embodiments, such an identifier and description text may be provided to other processing entities in the interactive scene. For example, such an identifier and description text may be provided to a processing entity associated with other roles, or a particular processing entity for scheduling, etc.

Still with reference to FIG. 2A, the electronic device 110 may display, in a role configuration control 215, a role indication element corresponding to the added one or more preset roles, for example, a role indication element 225 and a role indication element 230.

As shown in FIG. 2A, a role (e.g., the first debater of the positive side) corresponding to the role indication element 225 may be associated with a specified processing entity. Correspondingly, the role indication element 225 may display the image identifier (for example, the image identifier of Bot A) corresponding to the processing entity, the name of the role, and the nickname of the associated processing entity in the interactive scene.

As another example, the role corresponding to the role indication element 230 (e.g., the third debater of the con side) is associated with the vacant interactive object. In some scenes, the association to the vacant interactive object may indicate that the role is not provided with a corresponding preset processing entity. That is, other users may specify to participate in and associate with the role in the interaction process with the target application, or other processing entities may be selected and associated with the role.

Accordingly, as shown in FIG. 2A, the role indication element 230 may display corresponding object information (e.g., “vacant”) to indicate that it is associated with an vacant interactive object. In addition, the role indication element 230 may display preset image content.

Further, as shown in FIG. 2A, the configuration interface 200A may include an input control 235 configured to obtain the interaction control information. In some embodiments, the interaction control information may include text used to describe an interaction rule and/or control logic of the interactive scene.

In some embodiments, such interaction control information may be provided for creating a target processing entity (i.e., the host role mentioned above) in the interactive scene. In some embodiments, the target processing entity may be configured to manage an interaction process of the plurality of interactive objects in the interactive scene.

For example, the interaction control information may describe a process of an entire debate process, a speaking order between respective roles, content that needs to be output by a host role, and the like.

In some embodiments, such a target processing entity may be implemented based on a machine learning model. For example, the electronic device 110 may provide the interactive control information obtained by the input control 235 to a target model to instruct the target model to manage the interaction process of the plurality of interactive objects in the interactive scene according to the content described by the interaction control information.

Further, the electronic device 110 may, for example, receive a selection of a publishing entry 250 by the user to create and publish the target application based on the received configuration information.

### Example Interaction of Target Applications

In some embodiments, the electronic device 110 may receive a startup request or a debugging request of the user for the target application and may correspondingly present a session interface of the target application.

As an example, in the configuration interface 200A, the electronic device 110 may provide a debugging window 240, and may receive, via a debugging entry 245, a debugging request for the target application from the creator of the target application. As another example, a user (e.g., a creator or other user) may launch a target application through an entry corresponding to the target application.

In some embodiments, in response to the set of preset roles configured by the target application including the target role associated with the vacant interactive object, the electronic device 110 may present a settings window 200B as shown in FIG. 2B.

As shown in FIG. 2B, in a case that the configuration information received via FIG. 2A indicates that the role (for example, the third debater of the con side) is associated with a vacant interactive object, the electronic device 110 may configure, via the settings window 200B, an interactive object corresponding to the role (for example, the third debater of the con side).

In some embodiments, the electronic device 110 may, for example, configure the current user object as an interactive object corresponding to the role through a control 255. In this case, the user may participate in the target interactive scene through a session, for example.

Alternatively, the electronic device 110 may further receive a configuration operation of the user through a control 260, to configure a specified processing entity as the target interactive object corresponding to the role. For example, the electronic device 110 may present a group of candidate processing entities, for example, bots, with a preset permission for the current user. Further, the electronic device 110 may select a specific processing entity to associate the specific processing entity with the target role.

In some embodiments, if the set of preset roles includes a plurality of roles associated with a vacant interactive object, the electronic device 110 may, for example, support the user respectively configuring the interactive object corresponding to each role. In some embodiments, a single user object may only support association with a unique role, for example, or a single processing entity only supports association with a unique role.

In still other embodiments, if the set of preset characters are all associated with the preset processing entity, the electronic device 110 may not present the settings window 200B shown in FIG. 2B, and may directly present a session interface 200C shown in FIG. 2C instead.

As shown in FIG. 2C, in the session interface 200C, the electronic device 110 may present description information 265 about a plurality of interactive objects participating in the target interactive scene. In some embodiments, such description information may include a text identifier (for example, a nickname), an image identifier (for example, an avatar), a text description, and the like of each interactive object.

In some embodiments, if the role information of the role corresponding to the interactive object is visible to the role corresponding to the current interface (for example, the interactive object corresponding to the interface of FIG. 2C is user A), the electronic device 110 may present the role information about the role corresponding to the interactive object. For example, the electronic device 110 may display role information as “the first debater of the positive side” in association with the interactive object (e.g., BOT A).

In contrast, in some embodiments, if the role information of the role corresponding to the interactive object is invisible to the role corresponding to the current interface (for example, the interactive object corresponding to the interface of FIG. 2C is user A), the electronic device 110 may not present the role information about the role corresponding to the interactive object. For example, the electronic device 110 may display an “unknown role” in association with the interactive object.

In some embodiments, as shown in FIG. 2C, the electronic device 110 may display, in the interface 200C, an interactive message from a plurality of interactive objects joining the target interactive scene. As shown in FIG. 2C, after the user enters the target application, the first processing entity mentioned above (for example, corresponding to the host role) may provide a first interactive message 275-1, which is also an opening message.

In some embodiments, the electronic device 110 may further display corresponding interactive information 280-1 in association with such a first interactive message 275-1. As shown in FIG. 2C, such interactive information 280-1 may, for example, indicate a group of interactive objects to which the first interactive message 275-1 is sent.

As an example, if the interactive object corresponding to the session interface 200C is in the recipient list of the first interactive message 275-1, the session interface 200C may display the first interactive message 275-1. Otherwise, the session interface 200C will not display the first interactive message 275-1.

In some embodiments, the first processing entity may control the plurality of interactive objects participating in the interactive scene to provide the corresponding interactive message in a specified order based on the interactive control information described above. As an example, the first processing entity may, for example, sequentially control the interactive object corresponding to different debater roles to sequentially provide the interactive message according to a debate process.

As an example, as shown in FIG. 2D, the processing entity (BOT D) may, for example, provide a second interactive message 275-2 based on the flow indicated by the first processing entity. Similarly, the electronic device 110 may also present interactive information 280-2 about the second interactive message 275-2 to indicate a group of interactive objects to which the second interactive message 275-2 is sent.

In some embodiments, as shown in FIG. 2D, the first processing entity may further provide a third interactive message 275-3 for controlling the corresponding interactive object to respond. For example, the third interactive message 275-3 may indicate a particular role (e.g., the third debater of the con side and the third debater of the positive side) to respond sequentially.

As shown, interactive information 280-3 for the third interactive message 275-3 may indicate a first group of interactive objects that receive the third interactive message 275-3. Alternatively or additionally, the interactive information 280-3 may also indicate a second group of interactive objects to respond to the third interactive message 275-3, and/or a response sequence of the second group of interactive objects for the third interactive message 275-3.

Taking FIG. 2D as an example, the interactive information 280-3 may indicate that the interactive object (user A) and the interactive object (BOT C) respond to the third interactive message 275-3 in sequence.

In some embodiments, the electronic device 110 may further determine, via the control 270, an interactive object (for example, user A) associated with the current session interface. Further, the interactive message displayed by the electronic device 110 in the session interface may include only the interactive message associated with the interactive object (for example, user A) in the target interactive scene. For example, the electronic device 110 may display only the interactive message sent by user A in the session interface, and the message receiver includes the interactive message of user A.

In some embodiments, the electronic device 110 may also support the user to switch the interactive object associated with the current session interface via the control 270. In some embodiments, when the user is the application creator, the electronic device 110 may, for example, support the user to switch the session interface to any interactive object added to the interactive scene (including the processing entity corresponding to the host).

In some embodiments, the current user may join the target interactive scene by launching the published target application. Accordingly, the electronic device 110 may only support the user to switch to one or more interactive objects configured by the user, for example, a user object or a processing entity configured via the setting window 200B.

As an example, where the session interface switches to association to another interactive object, the electronic device 110 may switch the session interface to display an interactive message associated with the another interactive object. As an example, the electronic device 110 may display only the interactive message sent to the interactive object and the interactive message sent by the interactive object, for example.

In some embodiments, when the session interface is associated with the user object, the electronic device 110 may further adjust an interaction mode of a message input control 285 in the session interface based on the interaction state of the user object in the target interactive scene. In some embodiments, the interaction state of the user object may indicate whether the user object is determined as an interactive object to provide an interactive message.

As shown in FIG. 2D, if the current user object is determined as an interactive object to provide an interactive message, the electronic device 110 may enable the message input control 285 for obtaining an interactive message of the user object. As an example, the electronic device 110 may also provide a reminder regarding the input interactive message.

As another example, if the user object is not an interactive object to provide an interactive message, the electronic device 110 may accordingly disable or stop displaying the message input control 285. For example, in the state shown in FIG. 2C, the current user object does not reach the speaking round, and the electronic device 110 may not display the message input control 285, for example.

In some embodiments, the electronic device 110 may further support, for example, the user initiating a termination request through a control 290 to trigger at least one processing entity associated with the target application to stop generating the interactive message.

Specifically, the electronic device 110 may control the first processing entity to stop generating the indication information for controlling the corresponding processing entity to generate the interactive message based on the received termination request. Therefore, the electronic device 110 may control the first processing entity to stop advancing the subsequent process after the round of dialog response ends, thereby stopping generating the corresponding interactive message.

In some embodiments, the electronic device 110 may further support, for example, the user deleting one or more interactive messages from the session interface. Specifically, the electronic device 110 may support the user switching the session interface to be associated with the first processing entity, and may delete at least one interactive message corresponding to the specified dialog turn to update the context information associated with the interactive scene.

Specifically, such dialog turns may include an interactive message generated by the first processing entity and at least one response message provided by other interactive objects in response to the interactive message.

Taking FIG. 2D as an example, the interactive message 275-3 may be used as a start message of a new dialog turn, and may further include a response message generated by the interactive object (user A and BOT C). Thus, the electronic device 110 may support the user performing the message management according to the dialog turn.

Based on the process described above, the embodiments of the present disclosure can support interaction of a plurality of interactive objects in a session interface, and can manage an interactive process of a plurality of interactive objects via a processing entity.

### Example Process

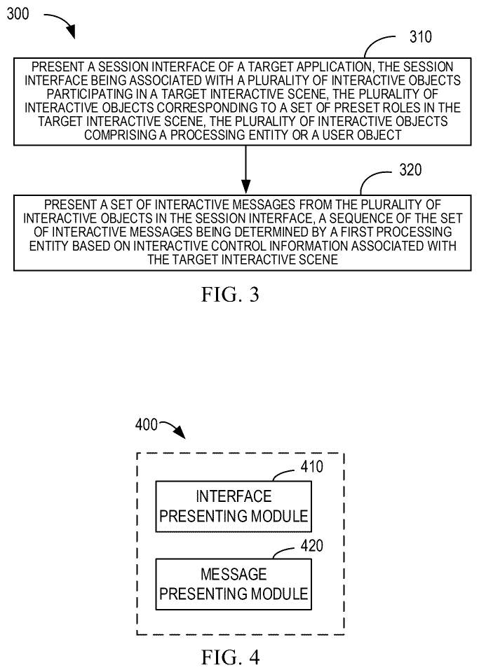

FIG. 3 illustrates a flowchart of an example interaction process 300 according to some embodiments of the present disclosure. The process 300 may be implemented at the electronic device 110. The process 300 is described below with reference to FIG. 1.

As shown, at block 310, the electronic device 110 presents a session interface of a target application, where the session interface is associated with a plurality of interactive objects participating in a target interactive scene, the plurality of interactive objects correspond to a set of preset roles in the target interactive scene, and the plurality of interactive objects include a processing entity or a user object.

At block 320, the electronic device 110 presents a set of interactive messages from the plurality of interactive objects in the session interface, and a sequence of the set of interactive messages is determined by a first processing entity based on interactive control information associated with the target interactive scene.

In some embodiments, the process 300 further comprises: receiving a launch request or a debugging request for the target application; presenting a setting window in response to a target role in the set of preset roles being associated with an vacant interactive object; and configuring, via the setting window, a target interactive object corresponding to the target role.

In some embodiments, configuring the target interactive object corresponding to the target role comprises:
configuring a current user object as the target interactive object corresponding to the target role; or configuring, based on a received configuration operation, a second processing entity as the target interactive object corresponding to the target role.

In some embodiments, presenting a set of interactive messages from the plurality of interactive objects in the session interface comprises: presenting a first interactive message and interactive information corresponding to the first interactive message in the session interface.

In some embodiments, the interactive information indicates at least one of: a first set of interactive objects to which the first interactive message is sent; a second set of interactive objects to respond to the first interactive message; a response sequence of the second set of interactive objects for the first interactive message.

In some embodiments, presenting a set of interactive messages from the plurality of interactive objects in the session interface comprises: determining a first interactive object associated with the session interface; and displaying, in the session interface, a first set of interactive messages associated with the first interactive object, the first set of interactive messages comprising an interactive message sent to the first interactive object and/or an interactive message sent by the first interactive object.

In some embodiments, presenting a set of interactive messages from the plurality of interactive objects in the session interface further comprises: receiving a request to switch the session interface to be associated with a second interactive object; and in response to the request, switching the session interface to display a second set of interactive messages associated with the second interactive object, the second set of interactive messages comprising an interactive message sent to the second interactive object and an interactive message sent by the second interactive object.

In some embodiments, the process 300 further comprises: in response to the session interface being associated with a user object, adjusting an interaction mode of a message input control in the session interface based on an interaction state of the user object in the target interactive scene, the interaction state indicating whether the user object is determined as an interactive object to provide an interactive message.

In some embodiments, adjusting the interaction mode of the message input control in the session interface comprises: in response to the interaction state indicating that the user object is an interactive object to provide an interactive message, enabling the message input control so as to obtain an interactive message of the user object; or in response to the interactive state indicating that the user object is not an interactive object to provide an interactive message, disabling or stopping displaying the message input control.

In some embodiments, presenting the session interface of the target application comprises:
presenting the session interface of the target application based on a launch request or a debugging request for the target application.

In some embodiments, the target application is created based on configuration information, the configuration information comprises the interaction control information and role setting information about a target interactive scene, where the interaction control information is used to construct the first processing entity; and the role setting information indicates the set of preset roles.

In some embodiments, the configuration information further comprises scene description information about the target interactive scene, where the scene description information is used to construct the first processing entity, or the scene description information is provided to another processing entity participating in the target interactive scene.

In some embodiments, the process 300 further comprises: in response to a received termination request, triggering at least one processing entity associated with the target application to stop generating an interactive message.

In some embodiments, triggering at least one processing entity associated with the target application to stop generating the interactive message comprises: controlling, based on the terminate request, the first processing entity to stop generating indication information for controlling a corresponding processing entity to generate an interactive message.

In some embodiments, the process 300 further comprises: in response to the session interface being associated with the first processing entity, deleting at least one interactive message corresponding to a specified dialog turn from the session interface based on a received delete request, to update context information associated with the interactive scene.

In some embodiments, the specified dialog turn comprises a second interactive message generated by the first processing entity and at least one response message provided by another interactive object in response to the second interactive message.

### Example Apparatus and Device

The embodiments of the present disclosure further provide a corresponding apparatus for implementing the above method or process. FIG. 4 shows a schematic structural block diagram of an example apparatus 400 for interaction according to some embodiments of the present disclosure. The apparatus 400 may be implemented as or included in the electronic device 110. The various modules/components in the apparatus 400 may be implemented by hardware, software, firmware, or any combination thereof.

As shown in FIG. 4, the apparatus 400 comprises: an interface presenting module 410 configured for presenting a session interface of a target application, where the session interface is associated with a plurality of interactive objects participating in a target interactive scene, the plurality of interactive objects correspond to a set of preset roles in the target interactive scene, and the plurality of interactive objects include a processing entity or a user object; and a message presenting module 420 configured for presenting a set of interactive messages from the plurality of interactive objects in the session interface, where a sequence of the set of interactive messages is determined by a first processing entity based on interactive control information associated with the target interactive scene.

In some embodiments, the interface presenting module 410 is further configured for: receiving a launch request or a debugging request for the target application; presenting a settings window in response to a target role in the set of preset roles being associated with an vacant interactive object; and configuring, via the settings window, a target interactive object corresponding to the target role.

In some embodiments, configuring the target interactive object corresponding to the target role comprises: configuring a current user object as the target interactive object corresponding to the target role; or configuring, based on a received configuration operation, a second processing entity as the target interactive object corresponding to the target role.

In some embodiments, presenting a set of interactive messages from the plurality of interactive objects in the session interface comprises: presenting a first interactive message and interactive information corresponding to the first interactive message in the session interface.

In some embodiments, the interactive information indicates at least one of: a first set of interactive objects to which the first interactive message is sent; a second set of interactive objects configured to respond to the first interactive message; or a response sequence of the second set of interactive objects for the first interactive message.

In some embodiments, presenting a set of interactive messages from the plurality of interactive objects in the session interface comprises: determining a first interactive object associated with the session interface; and displaying, in the session interface, a first set of interactive messages associated with the first interactive object, the first set of interactive messages comprising an interactive message sent to the first interactive object and/or an interactive message sent by the first interactive object.

In some embodiments, presenting a set of interactive messages from the plurality of interactive objects in the session interface further comprises: receiving a request to switch the session interface to be associated with a second interactive object; and in response to the request, switching the session interface to display a second set of interactive messages associated with the second interactive object, the second set of interactive messages comprising an interactive message sent to the second interactive object and an interactive message sent by the second interactive object.

In some embodiments, the interface presenting module 410 is further configured for: in response to the session interface being associated with a user object, adjusting an interaction mode of a message input control in the session interface based on an interaction state of the user object in the target interactive scene, the interaction state indicating whether the user object is determined as an interactive object to provide an interactive message.

In some embodiments, adjusting the interaction mode of the message input control in the session interface comprises: in response to the interaction state indicating that the user object is an interactive object to provide an interactive message, enabling the message input control so as to obtain an interactive message of the user object; or in response to the interactive state indicating that the user object is not an interactive object to provide an interactive message, disabling or stopping displaying the message input control.

In some embodiments, presenting the session interface of the target application comprises: presenting the session interface of the target application in response to a launch request or a debugging request for the target application.

In some embodiments, the target application is created based on configuration information, the configuration information comprises the interaction control information and role setting information about a target interactive scene, where the interaction control information is used to construct the first processing entity; and the role setting information indicates the set of preset roles.

In some embodiments, the configuration information further comprises scene description information about the target interactive scene, where the scene description information is used to construct the first processing entity, or the scene description information is provided to another processing entity participating in the target interactive scene.

In some embodiments, the message presenting module 420 is further configured for: in response to a received termination request, triggering at least one processing entity associated with the target application to stop generating an interactive message.

In some embodiments, triggering at least one processing entity associated with the target application to stop generating an interactive message comprises: controlling, based on the termination request, the first processing entity to stop generating indication information for controlling a corresponding processing entity to generate an interactive message.

In some embodiments, the interface presenting module 410 is further configured for: in response to the session interface being associated with the first processing entity, deleting at least one interactive message corresponding to a specified dialog turn from the session interface based on a received delete request, to update context information associated with the interactive scene.

In some embodiments, the specified dialog turn comprises a second interactive message generated by the first processing entity and at least one response message provided by another interactive object in response to the second interactive message.

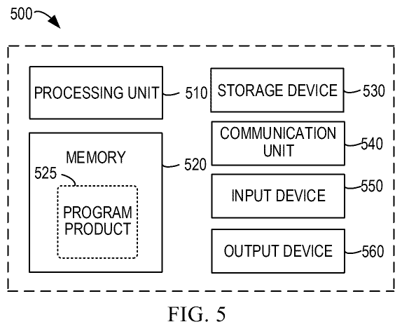

FIG. 5 illustrates a block diagram of an electronic device 500 in which one or more embodiments of the present disclosure may be implemented. It should be understood that the electronic device 500 shown in FIG. 5 is merely exemplary and should not constitute any limitation on the functionality and scope of the embodiments described herein. The electronic device 500 shown in FIG. 5 may be configured for implementing the terminal device 110 in FIG. 1.

As shown in FIG. 5, the electronic device 500 is in the form of a general purpose computing device. Components of the electronic device 500 may include, but are not limited to, one or more processors or processing units 510, a memory 520, a storage device 530, one or more communication units 540, one or more input devices 550, and one or more output devices 560. The processing unit 510 may be a physical or virtual processor and may execute various processing based on the programs stored in the memory 520. In a multi-processor system, a plurality of processing units executes computer-executable instructions in parallel to enhance parallel processing capability of the electronic device 500.

The electronic device 500 usually includes a plurality of computer storage mediums. Such mediums may be any attainable medium accessible by the electronic device 500, including but not limited to, a volatile and non-volatile medium, a removable and non-removable medium. The memory 520 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 530 may be a removable or non-removable medium, and may include a machine-readable medium (e.g., a memory, a flash drive, a magnetic disk) or any other medium, which may be used for storing information and/or data (e.g., training data for training) and be accessed within the electronic device 500.

The electronic device 500 may further include additional removable/non-removable, volatile/non-volatile storage mediums. Although not shown in FIG. 8, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 520 may include a computer program product 525 having one or more program modules, and these program modules are configured for performing various methods or acts of various implementations of the present disclosure.

The communication unit 540 implements communication with another computing device via a communication medium. Additionally, functions of components of the electronic device 500 may be realized by a single computing cluster or a plurality of computing machines, and these computing machines may communicate through communication connections. Therefore, the electronic device 500 may operate in a networked environment using a logic connection to one or more other servers, a Personal Computer (PC) or a further general network node.

The input device 550 may be one or more various input devices, such as a mouse, a keyboard, a trackball, a voice-input device, and the like. The output device 560 may be one or more output devices, e.g., a display, a loudspeaker, a printer, and so on. The electronic device 500 may also communicate through the communication unit 540 with one or more external devices (not shown) as required, where the external device, e.g., a storage device, a display device, and so on, communicates with one or more devices that enable users to interact with the electronic device 500, or with any device (such as a network card, a modem, and the like) that enable the electronic device 500 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

1. An interaction method, comprising:
presenting a session interface of a target application, the session interface being associated with a plurality of interactive objects participating in a target interactive scene, the plurality of interactive objects corresponding to a set of preset roles in the target interactive scene, and the plurality of interactive objects comprising a processing entity or a user object; and
presenting a set of interactive messages from the plurality of interactive objects in the session interface, a sequence of the set of interactive messages being determined by a first processing entity based on interactive control information associated with the target interactive scene.

2. The method of claim 1, further comprising:
receiving a launch request or a debugging request for the target application;
presenting a settings window in response to a target role in the set of preset roles being associated with a vacant interactive object; and
configuring, via the settings window, a target interactive object corresponding to the target role.

3. The method of claim 2, wherein configuring the target interactive object corresponding to the target role comprises:
configuring a current user object as the target interactive object corresponding to the target role; or
configuring, based on a received configuration operation, a second processing entity as the target interactive object corresponding to the target role.

4. The method of claim 1, wherein presenting a set of interactive messages from the plurality of interactive objects in the session interface comprises:
presenting a first interactive message and interactive information corresponding to the first interactive message in the session interface.

5. The method of claim 4, wherein the interactive information indicates at least one of:
a first set of interactive objects to which the first interactive message is sent;
a second set of interactive objects configured to respond to the first interactive message; or
a response sequence of the second set of interactive objects for the first interactive message.

6. The method of claim 1, wherein presenting a set of interactive messages from the plurality of interactive objects in the session interface comprises:
determining a first interactive object associated with the session interface; and
displaying, in the session interface, a first set of interactive messages associated with the first interactive object, the first set of interactive messages comprising an interactive message sent to the first interactive object and/or an interactive message sent by the first interactive object.

7. The method of claim 6, wherein presenting a set of interactive messages from the plurality of interactive objects in the session interface further comprises:
receiving a request to switch the session interface to be associated with a second interactive object; and
in response to the request, switching the session interface to display a second set of interactive messages associated with the second interactive object, the second set of interactive messages comprising an interactive message sent to the second interactive object and/or an interactive message sent by the second interactive object.

8. The method of claim 1, further comprising:
in response to the session interface being associated with a user object, adjusting an interaction mode of a message input control in the session interface based on an interaction state of the user object in the target interactive scene, the interaction state indicating whether the user object is determined as an interactive object to provide an interactive message.

9. The method of claim 8, wherein adjusting the interaction mode of the message input control in the session interface comprises:
in response to the interaction state indicating that the user object is an interactive object to provide an interactive message, enabling the message input control so as to obtain an interactive message of the user object; or
in response to the interactive state indicating that the user object is not an interactive object to provide an interactive message, disabling or stopping displaying the message input control.

10. The method of claim 1, wherein presenting the session interface of the target application comprises:
presenting the session interface of the target application in response to a launch request or a debugging request for the target application.

11. The method of claim 1, wherein the target application is created based on configuration information, the configuration information comprises the interaction control information and role setting information about a target interactive scene, wherein the interaction control information is used to construct the first processing entity, and the role setting information indicates the set of preset roles.

12. The method of claim 11, wherein the configuration information further comprises scene description information about the target interactive scene,
wherein the scene description information is used to construct the first processing entity, or the scene description information is provided to another processing entity participating in the target interactive scene.

13. The method of claim 1, further comprising:
in response to a received termination request, triggering at least one processing entity associated with the target application to stop generating an interactive message.

14. The method of claim 13, wherein triggering at least one processing entity associated with the target application to stop generating an interactive message comprises:
controlling, based on the termination request, the first processing entity to stop generating indication information for controlling a corresponding processing entity to generate the interactive message.

15. The method of claim 1, further comprising:
in response to the session interface being associated with the first processing entity, deleting at least one interactive message corresponding to a specified dialog turn from the session interface based on a received delete request, to update context information associated with the interactive scene.

16. The method of claim 15, wherein the specified dialog turn comprises a second interactive message generated by the first processing entity and at least one response message provided by another interactive object in response to the second interactive message.

17. An electronic device, comprising:
at least one processing unit; and
at least one memory coupled to the at least one processing unit and storing instructions executed by the at least one processing unit, the instructions, when executed by the at least one processing unit, causing the electronic device to perform an interaction method comprising:
presenting a session interface of a target application, the session interface being associated with a plurality of interactive objects participating in a target interactive scene, the plurality of interactive objects corresponding to a set of preset roles in the target interactive scene, the plurality of interactive objects comprising a processing entity or a user object; and
presenting a set of interactive messages from the plurality of interactive objects in the session interface, a sequence of the set of interactive messages being determined by a first processing entity based on interactive control information associated with the target interactive scene.

18. The electronic device of claim 17, wherein the method further comprises:
receiving a launch request or a debugging request for the target application;
presenting a settings window in response to a target role in the set of preset roles being associated with a vacant interactive object; and
configuring, via the settings window, a target interactive object corresponding to the target role.

19. The electronic device of claim 18, wherein configuring the target interactive object corresponding to the target role comprises:
configuring a current user object as the target interactive object corresponding to the target role; or
configuring, based on a received configuration operation, a second processing entity as the target interactive object corresponding to the target role.

20. A computer-readable storage medium, storing a computer program thereon, the computer program, when executed by a processor, implementing an interaction method comprising:
presenting a session interface of a target application, the session interface being associated with a plurality of interactive objects participating in a target interactive scene, the plurality of interactive objects corresponding to a set of preset roles in the target interactive scene, the plurality of interactive objects comprising a processing entity or a user object; and
presenting a set of interactive messages from the plurality of interactive objects in the session interface, a sequence of the set of interactive messages being determined by a first processing entity based on interactive control information associated with the target interactive scene.
